(19) United States
(12) Patent Application Publication
(10) Pub. No.: US 2015/0014284 A1
(43) Pub. Date: Jan. 15, 2015

(54) HYBRID MIG-TIG OR MAG-TIG WELDING DEVICE

(71) Applicant: Air Liquide Welding France, Paris (FR)

(72) Inventors: Nicolas Burvelle, Osny (FR); Jean-Pierre Planckaert, Monneville (FR)

(21) Appl. No.: 14/327,122

(22) PCT Filed: Dec. 5, 2012
(86) PCT No.: PCT/FR2012/052808

§ 371 Date: Jul. 9, 2014

(30) Foreign Application Priority Data
Jan. 11, 2012 (FR) 1250270

(51) Int. Cl. B23K 9/167; B23K 35/38; B23K 9/23; B23K 9/173

(52) U.S. Cl. CPC B23K 9/1675; B23K 9/1735; B23K 35/38; B23K 9/23
USPC 219/75

(57) ABSTRACT

A hybrid MIG-TIG or MAG-TIG welding device including a MIG or MAG welding torch utilizing a consumable wire oriented in a first direction, associated with a TIG welding torch utilizing a non-consumable electrode oriented in a second direction, said first and second directions being substantially coplanar and forming between themselves an angle (α) no less than 5° and no greater than 40° is provided.

### CROSS REFERENCE TO RELATED APPLICATIONS

This application is a 371 of International PCT Application PCT/FR2012/052808 filed Dec. 5, 2012, which claims priority to French Application No. 1250270 filed Jan. 11, 2012, the entire contents of which are incorporated herein by reference.

### BACKGROUND

The invention relates to a welding device combining a MIG or MAG torch and a TIG torch, and allowing a simpler and faster implementation of a MIG-TIG or MAG-TIG welding method. The invention also relates to a hybrid MIG-TIG or MAG-TIG method for welding metal parts using the inventive welding device, in particular a method for the high-speed welding of thin metal parts.

Welding methods known as MIG, for “Metal Inert Gas”, or MAG, for “Metal Active Gas”, rely on the use of an electric arc between the end of one consumable metal wire and the metal parts to be welded. The heat of the electric arc melts the metal that forms the parts to be welded, as well as the metal that forms the consumable wire, i.e. the filler metal, which generates a weld pool, i.e. a pool of liquid metal, formed of the metal of the parts to be welded and the metal of the molten consumable wire transferred into the electric arc.

A weld bead is obtained through the gradual re-solidification of the weld pool and the relative movement of the consumable wire and the metal parts. Furthermore, a flow of inert gas is distributed across the weld pool by a nozzle positioned above the parts to be welded so as to protect the molten metal from the ambient air.

During the MIG or MAG welding operation, a flow of shielding gas is distributed across the weld pool by a nozzle positioned above the parts to be welded so as to protect the molten metal from the ambient air.

The difference between the MIG and MAG welding methods resides in the nature of the shielding gas used, namely an inert gas in the MIG method, and an active gas, more specifically an oxidizing gas, in the MAG method.

The MIG or MAG welding method is generally carried out with a MIG or MAG welding torch that holds the metal wire used as a consumable electrode and the nozzle capable of distributing the shielding gas of the weld pool. The MIG or MAG torch is electrically connected to at least one current generator that transmits a smooth or pulsed current of about 100 to 500 A; that torch is also generally fluidly connected to at least one source of inert gas. These elements taken together, namely the welding torch, current generator, source of gas, electrical power cables, gas supply networks, and mechanical elements such as the support frames and/or moving beams on which the torch is arranged, are comprised within an assembly known as a MIG or MAG welding installation.

Normally, the MIG or MAG welding method is used to weld metal parts formed of different metallic materials, particularly parts made of ferrous alloys, aluminum, or aluminum alloys, and preferably stainless steel or carbon steel.

It should be noted that the term “metal parts” refers to at least two distinct metal parts, or a single piece to be welded with itself, such as the two longitudinal edges of a metal sheet in order to form a welded tube.

Besides the time needed to prepare the parts before welding and the percentage of weld beads rejected, the productivity of a MIG or MAG welding method is governed mostly by the welding speed of the metal parts.

In order to increase the productivity of the MIG or MAG welding method, one obvious solution is therefore to increase the welding speed, meaning the relative movement speed of the consumable wire and the metal parts to be welded.

However, in some cases it has been noted that MIG or MAG welding speeds cannot be increased above a limit value, at which point defects start to appear in the weld beads. In particular, the appearance of these defects is observed during the welding of thin metal parts, typically those less than 2 mm thick, also known as thin plates, for which the welding speeds are relatively high, generally between 1.5 and 2 m/min.

One commonly observed defect comes in the form of a change in the morphology of the weld bead obtained by MIG or MAG welding, and is known as “humping”. It appears as a series of periodic oscillations, otherwise known as humps, on the surface of the weld bead, and leads to two types of bead morphologies: gouging region morphology (GRM) and beaded cylinder morphology (BCM).

The mechanisms that lead to the appearance of humping are complex, and involve fluid mechanics and the thermal and physical properties of the electric arc used in MIG and MAG welding. For example, the appearance of the BCM defect is related to bad wetting that generates a pinching instability similar to the one presented in the Rayleigh theory. In fact, the GRM defect appears because the weld pool is very heavily driven to the rear of the welding arc because of the constraints exerted. These constraints result from the quantity of movement of the consumable wire's metal drops transferred into the electric arc and the magnetic pressure exerted by the electric arc.

Generally speaking, the humping defect appears at high welding speeds because of the elongation of the weld pool, since the thin film of liquid metal located under the electric arc and behind it become vulnerable to early solidification in the form of a thickening of metal in the humps. Repeated periodically, this phenomenon will result in a series of troughs and humps on the surface of the weld bead.

The humping defect is well known, and is particularly described in the following documents:
T. C. Nguyen et al, The humping phenomenon during high speed gas metal arc welding, Science and technology of welding and joining, 2005, vol. 10, no 4, pp. 447-459,
M. H. Cho and D. F. Farson, Understanding bead hump formation in gas metal arc welding using a numerical simulation, Metallurgical and materials transactions B, vol. 38B, pp. 305-319,
T. C. Nguyen, D. C. Weckman and D. A. Johnson, The discontinuous weld bead defect in high-speed gas metal arc welds, Welding Journal, 2007, vol. 86, no 11, pp. 360-372, and
H. W. Choi, D. F. Farson and M. H. Cho, Using a hybrid laser plus GMAW process for controlling the bead humping defect, Welding Journal, 2006, vol. 85, no 8, pp. 174-179.

However, the humping defect is not acceptable from an industrial standpoint, not just because of the sight of the resulting weld beads, but also because it leads to degradation in the mechanical properties of those beads.

It is then necessary to reduce the welding speed in order to obtain weld beads, which hurts the productivity of the MIG or MAG welding method and therefore poses a major problem.

There are multiple solutions for solving this problem in increasing the MIG or MAG welding speeds without the weld beads taking on a humpy appearance, such as preheating the metal parts before MIG or MAG welding, or using two synchronized MIG or MAG torches.

However, all of these solutions are complicated to implement, excessively complicating the MIG or MAG welding installation or leading to a resultant increase in the electrical power used during the welding operation, which also hurts the efficiency and productivity of the MIG or MAG welding installation.

An alternative solution for increasing the MIG or MAG welding speeds without the weld beads taking on a humpy appearance has previously been proposed by the inventors of the present invention.

It consists of using a welding device formed of a TIG (Tungsten Inert Gas) welding torch, combined with the MIG or MAG welding torch, meaning a hybrid MIG-TIG or MAG-TIG device. A TIG electric arc appears between a non-consumable electrode made of tungsten disposed within the welding torch TIG and the metal parts to be welded. The TIG torch is also equipped with a nozzle that delivers a flow of inert gas to protect the weld pool. The TIG electric arc is positioned after the MIG or MAG electric arc, meaning that it is positioned to the rear of the MIG or MAG electric arc along the direction of welding, and that it moves at the same time.

The effect produced by the TIG arc during the welding method is illustrated in the attached FIG. 1. That figure diagrams the welding of metal parts formed by a base metal 20. The molten metal pool generated by the heat provided by the MIG or MAG electric arc between the consumable wire 1a and the metal parts to be welded partially solidifies (in 21) while remaining coated with a thin film of liquid metal 22. A TIG electric arc between the non-consumable electrode 2a and the parts to be welded is positioned after the MIG or MAG arc, along the direction of welding 25.

First, that TIG arc provides a flow of localized heat (in 24) that makes it possible to delay the early solidification of the thin film of liquid metal that appears in the wake of the MIG or MAG electric arc. Second, the TIG arc exerts pressure onto the lump of molten metal (in 23) that appears at the rear end of the weld pool and leads to the appearance of the humping defect.

More specifically, the consumable wire 1a of the MIG or MAG torch is oriented in a first given direction, and the non-consumable electrode 2a of the welding torch TIG is oriented in a second given direction. Said first and second directions are substantially coplanar, and form an angle typically greater than 5° and less than 40°. The end of the electrode of the TIG welding torch is located between 20 and 44 mm away from said first direction.

This hybrid MIG-TIG or MAG-TIG welding device has the advantage of not having to heat a large portion of the parts to be welded. One area of the weld bead is briefly treated shortly after it is formed with a TIG arc, so the additional expenditure of energy due to using the TIG torch remains moderate.

The document U.S. Pat. No. 6,693,252 teaches, for example, a MIG-TIG welding device in which the TIG welding torch is rigidly joined with a MIG welding torch.

Nonetheless, this device has a certain number of shortcomings, particularly because it does not offer any flexibility regarding the distance separating the TIG and MIG torches.

Instead, the TIG torch must be mechanically linked to the MIG torch in order to be able to follow it in its movements and operate simultaneously. Furthermore, the hybrid MIG-TIG or MAG-TIG welding device must comprise means of adjustment, such as one or more jacks, gears, etc. that make it possible to accurately adjust the relative positions of said welding torches with respect to one another, meaning the distance between said torches or between them and the parts to be welded, or the torches' different angles of inclination.

In particular, depending on the nature of the material of the metal parts to be welded, it is necessary to adapt the distance separating the end of the electrode of the TIG welding torch and the first orientation direction of the consumable wire of the MIG or MAG torch.

For example, when the metal parts to be welded are made of stainless steel, the end of the non-consumable electrode must be located a given distance D away from said first orientation direction of the consumable wire. When the metal parts to be welded are made of carbon steel, the end of the non-consumable electrode must be located a given distance D′ away from said first orientation direction of the consumable wire, the distance D′ being greater than the distance D.

However, this requires readjusting the relative positions of the TIG and MIG or MAG welding torches with respect to one another every time the material of the metal parts to be welded changes. The result is that more time is needed to prepare the device before the welding operation, and therefore some of the welding installation's productivity is lost.

In order to remedy this problem, one solution is to dispose as many hybrid MIG-TIG or MAG-TIG welding devices, in other words as many assembly configurations of MIG or MAG torches and TIG torches, as there are types of metal material to be welded.

However, this solution is not ideal, because it increases the overall cost of the welding installation and also does not solve the problem of more time taken to prepare the device before the welding operation. This is because it is necessary in such a case to assemble and remove the hybrid MIG-TIG or MAG-TIG welding device from the frame or mobile beam on to which it is generally arranged.

### SUMMARY

In view of this, the problem to be solved is that of proposing an improved MIG welding device, meaning one that makes it possible to increase the welding speed without the resulting weld beads having any “humping” defects, does not excessively complicate the welding insulation, does not require too much additional energy, and is also easy and fast to implement.

In other words, the problem to be solved is that of proposing an improved MIG or MAG welding device that either does not require or at least requires only a very limited number of mechanical adjustments before its implementation, and which is suitable and designed for welding metal parts regardless of the nature of the material that makes up said parts.

The solution of the invention is a hybrid MIG-TIG or MAG-TIG welding device comprising a MIG or MAG welding torch comprising a consumable wire oriented in a first direction, associated with a TIG welding torch comprising a non-consumable electrode oriented in a second direction, said first and second directions being substantially coplanar and forming between themselves an angle no less than 5° and no greater than 40°,

characterized in that it further comprises a torch assembly shoe suitable and designed for allowing a positioning of the TIG welding torch in at least two predefined positions relative to the MIG or MAG welding torch, comprising:
a first position in which the end of the non-consumable electrode is located at a first distance away from the first direction, and
a second position in which the end of the non-consumable electrode is located at a second distance away from the first direction, the second distance being greater than the first distance.

Furthermore, depending on the embodiment, the invention may comprise one or more of the following characteristics:
the assembly shoe comprises an axial lodging traversing the shoe in the first direction, inside which the MIG or MAG welding torch is arranged, a first lateral lodging traversing the shoe in which the TIG welding torch is arranged when positioned in the first position, and a second lateral lodging traversing the shoe inside which the TIG welding torch is arranged when positioned in the second position.
the first distance is comprised between 20 and 26 mm.
the second distance is comprised between 36 and 44 mm.
said first and second directions form between themselves an angle no less than 10° and no greater than 30°.
said first and second directions form an angle no less than 15° and no greater than 25°, preferably between 18 and 23°, and advantageously 20°.
the shoe further comprises means of fastening for holding the TIG welding torch into the first or second lateral lodgings.
the shoe further comprises means of translationally adjusting the position of the MIG or MAG welding torch along the first direction.
the hybrid welding device further comprises a clamp arranged in the axial lodging and into which the MIG or MAG welding torch is inserted.
the shoe is formed of one block.
the shoe is made of aluminum.

According to another aspect, the invention also pertains to a hybrid MIG-TIG or MAG-TIG welding installation comprising a MIG or MAG welding torch and a TIG welding torch electrically connected to at least one current generator and fluidly connected to at least one source of gas, characterized in that it further comprises a moving beam onto which is arranged a hybrid MIG-TIG welding device according to the invention, said hybrid MIG-TIG or MAG-TIG welding device being mobile or not, and a numerical control suitable and designed for controlling the movement of the moving beam and/or the hybrid MIG-TIG or MAG-TIG welding device.

Furthermore, the invention also relates to a method for the hybrid MIG-TIG or MAG-TIG welding of metal parts (30) implementing a hybrid MIG-TIG or MAG-TIG welding device according to the invention and wherein, during welding:
a MIG or MAG electric arc is established between the consumable wire of the MIG or MAG welding torch and the metal parts to be welded so as to generate a weld pool, said MIG or MAG electric arc being protected by a gas flow containing mainly at least one inert compound chosen from helium and argon, and
a TIG electric arc is established between the non-consumable electrode of the TIG welding torch and the metal parts to be welded on at least some of said weld pool, said TIG electric arc being shielded by a gas flow containing mainly argon or a mixture of helium and argon.

Preferably, the inventive method comprises one or more of the following characteristics:
the MIG or MAG electric arc is shielded by a flow of gas containing at least 80% of at least one inert compound chosen from among helium and argon (% by volume).
the flow of gas shielding the MIG or MAG electric arc further contains a minority compound with an oxidizing chemical effect chosen from CO₂ and O₂.
when the welded parts are made of stainless steel, the flow of gas shielding the MIG or MAG electric arc contains about 98% argon and 2% CO₂ (% by volume).
when the welded parts are formed of carbon steel, the flow of gas shielding the MIG or MAG electric arc contains about 92% argon and 8% CO₂ or 82% argon and 18% CO₂ (% by volume).
the flow of gas shielding the TIG electric arc contains essentially argon, preferably at least 99.9% argon (% by volume).
the flow of gas shielding the TIG electric arc contains at least 95% argon and hydrogen (% by volume).
the flow of gas shielding the TIG electric arc contains a mixture of helium and argon.
the flow of gas shielding the TIG electric arc contains a mixture of 80% argon and 20% helium (% by volume).
the flow of gas shielding the TIG electric arc contains a mixture of 30% argon and 70% helium (% by volume).

### BRIEF DESCRIPTION OF THE DRAWINGS

The invention will now be better understood through the detailed description that follows, with reference to the attached Figures in which:

FIG. 2 diagrams a MIG-TIG or MAG-TIG welding device according to one embodiment of the invention,

FIG. 3 diagrams a MIG or MAG and TIG torch assembly shoe according to one embodiment of the invention,

FIG. 4 illustrates a clamp for a MIG torch used in one embodiment of the invention.

### DESCRIPTION OF PREFERRED EMBODIMENTS

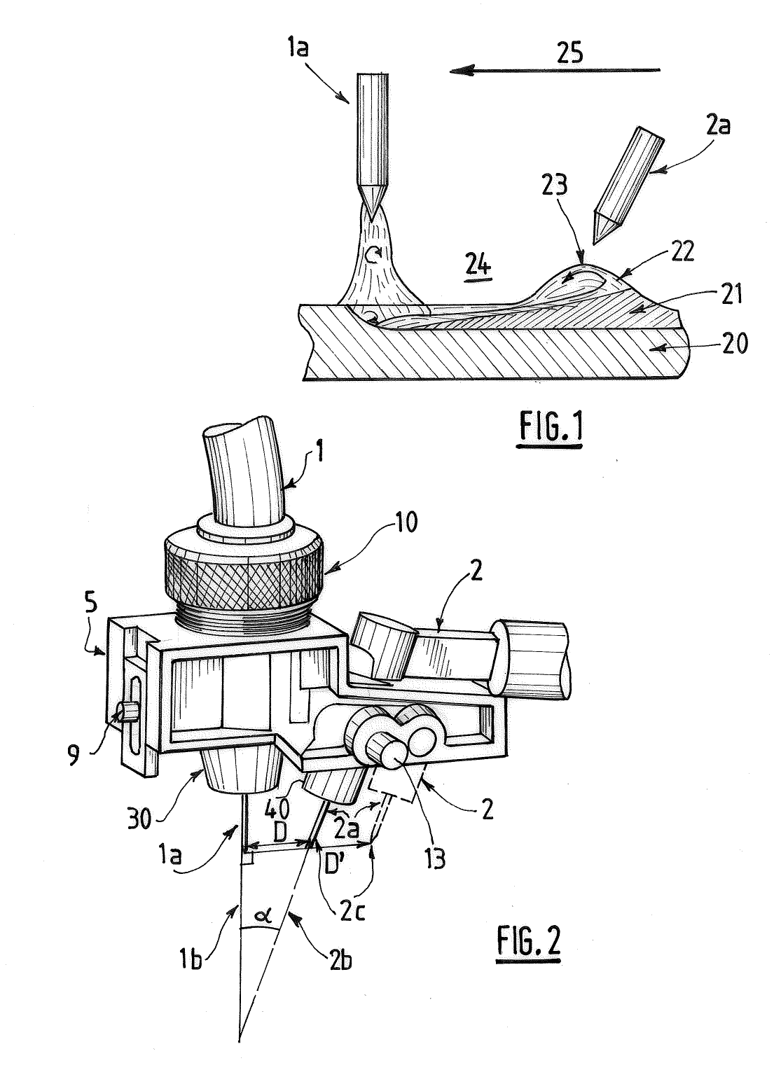

FIG. 2 diagrams a hybrid MIG-TIG or MAG-TIG welding device, hereafter known as a hybrid welding device, according to one embodiment of the invention.

As seen in FIG. 2, the hybrid MIG-TIG or MAG-TIG welding device comprises a MIG or MAG welding torch 1 comprising, at its end facing the parts to be welded, a metal consumable wire 1a. The consumable wire 1a is oriented in a first direction 1b.

Preferably, when metal parts to be welded are positioned facing the MIG or MAG welding torch 1, the first direction 1b is perpendicular to the upper surface of said parts. When welding parts that are held flat, i.e. horizontally, the first direction 1b therefore forms an angle on the order of 0° with the vertical.

The hybrid welding device also comprises a TIG welding torch 2 comprising, at its end facing the parts to be welded, a non-consumable electrode 2a. The end 2c of the electrode 2a is formed of a point that has been sharpened into a cone. More precisely, this sharpening has the general shape of a cone of revolution whose aperture angle is no less than 20° and no greater than 40°, and preferably on the order of 30°.

The electrode 2a is oriented in a second direction 2b, said first and second directions 1b and 2b being substantially coplanar and forming between themselves an angle α comprised between 5 and 40°. Preferably, the angle α is no less than 10° and no greater than 30°, more preferably 15°-25°, advantageously 18°-23°, and ideally on the order of 20°.

Preferentially, the plane containing the first and second directions 1b and 2b is perpendicular to the surface of the parts to be welded.

According to the invention, the hybrid welding device further comprises an assembly shoe 5 of torches 1 and 2, in which they are arranged. The MIG or MAG welding torch 1 is arranged in the shoe 5, said shoe 5 being suitable and designed for allowing a TIG welding torch 2 to be positioned in at least two predefined positions relative to the MIG or MAG welding torch 1.

These at least two predefined positions comprise a first position in which the end 2c of the non-consumable electrode 2a is located a first distance D away from the first direction 1b, and a second position in which the end 2c of the non-consumable electrode 2a is located a second distance D′ away from the first direction 1b, the second distance D′ being greater than the first distance D. FIG. 2 depicts one embodiment wherein the TIG welding torch 2 can be arranged in two positions relative to the MIG or MAG welding torch.

As depicted in FIG. 2, the distances D and D′ are defined as the distances separating a first point corresponding to the position of the end 2c of the non-consumable electrode 2a and a second point resulting from the orthogonal projection of the first point along the axis defined by the direction 1b.

Within the scope of the invention, the distance D is typically comprised between 20 and 26 mm. These values are particularly advantageous when seeking to weld metal parts made of stainless steel. Ideally, for welding stainless steel parts, the distance D is on the order of 24 mm.

The distance D′ is typically comprised between 36 and 44 mm. These values are particularly advantageous when seeking to weld parts made of mild steel, i.e. carbon steel. Ideally, for welding mild steel parts, the distance D′ is on the order of 40 mm.

Optionally, the device of the invention may comprise a shoe 5 allowing additional positions of the TIG torch relative to the MIG or MAG torch 1. The end 2c of the non-consumable electrode 2a may then be positioned as many additional distances D″, D′″ away as there are additional positions permitted by the shoe 5.

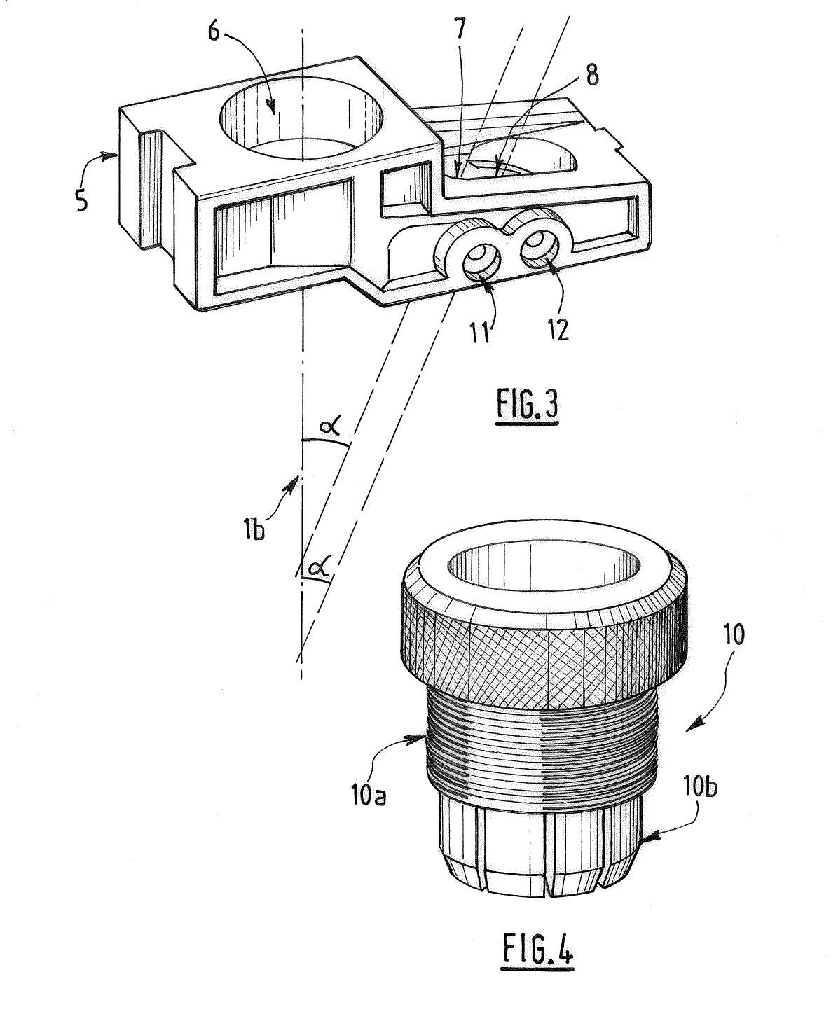

The assembly shoe 5 of the hybrid welding device of the invention is illustrated in FIG. 3, without a MIG or MAG welding torch 1 or a TIG welding torch 2 being arranged therein.

In accordance with the invention, the assembly shoe 5 comprises an axial lodging 6 traversing the shoe 5 along its entire thickness in a first direction 1b and whose opening faces the metal parts to be welded. This axial lodging 6 accommodates the MIG or MAG welding torch 1. Preferably, the axial lodging 6 is a passageway having a cylinder-shaped cross-section formed in the thickness of the shoe 5. The axial lodging 6 can comprise variations in the dimensions of its inner diameter along the first direction 1b, meaning expansions or contractions of that diameter, or it may have a constant inner diameter along the first direction 1b. Optionally, the axial lodging 6 may comprise, along all or some of its inner wall, a portion comprising a first threading. The end of the MIG or MAG torch 1 equipped with consumable wire 1a and a nozzle 30 that distributes shielding gas extends underneath the shoe 5, meaning that it is positioned between the shoe 5 and the surface of the metal parts to be welded located facing the welding device.

Furthermore as shown in FIG. 2, the assembly shoe 5 comprises means 9 for translationally adjusting the MIG or MAG welding torch 1 along the first direction 1b. According to one embodiment, these means 9 for translational adjustment comprise at least one screw that can move translationally in an oblong hole formed in a wedge placed on the side of the shoe 5. Said wedge can slide parallel to the first direction 1b. In this manner, the length of the wedge extending beneath the shoe 5 can be adjusted. For example, by adjusting the length of the wedge extending beneath the shoe 5 to 10 mm, which is done by moving the entire device along a flat surface while ensuring that the upper surface of the shoe 5 is parallel to it and lowering the torch 1 until it is in contact with that flat surface, one should make sure that the torch length extending beneath the shoe 5 is 10 mm.

The means 9 enable an accurate adjustment of the portion of the end of the MIG or MAG torch 1 that extends past the shoe 5. It is thereby possible to adjust the distance between the nozzle 30 equipping the end of the MIG or MAG torch 1 and the metal parts to be welded, as that distance forms one of the parameters of the welding method carried out by the device of the invention.

According to one particular embodiment of the invention, as depicted in FIG. 2, the hybrid welding device of the invention further comprises a clamp 10 in which the MIG or MAG welding torch 1 is arranged. This clamp 10 is itself arranged in the axial lodging 6 and serves as an adapter for arranging any type of MIG or MAG welding torch 1 into the axial lodging 6 of the assembly shoe 5.

One embodiment of the clamp 10 is diagrammed in FIG. 4. In this case, the clamp 10 is a rotationally symmetrical part comprising a portion 10a cylindrical in shape whose outer diameter corresponds to the inner diameter of the axial lodging 6. A second thread is built on to the outer surface of the portion 10a of the clamp 10, the step of that second thread being adapted to the step of the first thread builds on all or some of the inner wall of the axial lodging 6 so that the clamp 10 can be screwed into the axial lodging 6. The clamp 10 also comprises a portion 10b suitable and designed for tightening and holding the MIG or MAG torch 1.

Furthermore, as depicted in FIG. 3, the assembly shoe 5 comprises a first lateral lodging 7 traversing said shoe 5 inside which the TIG welding torch 2 is arranged when positioned in the first position.

The assembly shoe 5 also comprises a second lateral lodging 8 traversing the shoe 5 inside which the TIG welding torch 2 is arranged when positioned in the first position.

More specifically, the lateral lodgings 7 and 8 are passageways traversing the shoe 5 along its entire thickness and whose opening faces the metal parts to be welded. Preferably, the lateral lodgings 7 and 8 are passageways having a cylinder-shaped cross-section formed in the thickness of the shoe 5. The central axes of these passageways, depicted as dashed lines ( - - - ) in FIG. 3, form in accordance with the invention an angle α with the axis of the axial lodging 6 coinciding with the first direction 1b, depicted by the continuous line (______).

The lateral lodgings 7 and 8 may comprise variations in the dimensions of their inner diameters along their central axes, meaning expansions or contractions of those diameters, or may have constant inner diameters along their central axes. Optionally, the lateral lodging 7 or the lateral lodging 8 may comprise a contraction of its inner diameter, forming a shoulder against which at least part of the TIG welding torch 2 comes to rest.

The end of the TIG torch 2 equipped with the non-consumable electrode 2a and a nozzle 40 for distributing the shielding gas also extends beneath the shoe 5, meaning that it is positioned between the shoe 5 and the surface of the metal parts to be welded located facing the welding device.

The shoe 5 comprises fastening means 11, 13 or 12, 13 of the TIG welding torch 2 into the first or second lateral lodging 7, 8. According to one embodiment, depicted in FIGS. 2 and 3, the fastening means comprise lateral orifices 11 or 12 into which a screw or threaded pin 13 can be arranged. The pin or screw 13 is placed into the orifice 11 of the shoe 5 when the TIG torch 2 is positioned in the first position and in the orifice 12 of the shoe 5 when the TIG torch 2 is positioned in the second position. The pin or screw 13 traverses the thickness of the shoe 5 in which the orifices 11 and 12 are formed, and holds the TIG 2 torch in place.

Optionally, the device of the invention comprises a set of spacers enabling the user to adapt all types of TIG torches or MIG or MAG torches into the lodgings 6, 7 or 8 of the shoe 5.

To improve the mechanical robustness of the device of the invention, the shoe 5 is advantageously formed from one block, meaning that the shoe 5 is formed of a single block and not an assembly of parts. The lodgings 6, 7 and 8 are formed in that block by machining or drilling. Preferably, the shoe 5 is made of aluminum.

According to another aspect, the invention also pertains to a hybrid MIG-TIG or MAG-TIG welding insulation comprising a MIG or MAG welding torch 1 and a TIG welding torch 2 electrically connected to at least one current generator. The torches 1 and 2 are also fluidly connected to at least one source of gas that serves to supply the nozzles 30 and 40 with shielding gas.

Furthermore, the hybrid MIG-TIG or MAG-TIG welding installation comprises a moving beam onto which the hybrid welding device according to the invention is arranged. Said hybrid welding device may itself be movable on the beam, or not. The installation further comprises a numerical control suitable and designed for controlling the movement of the moving arm and/or the hybrid welding device on said beam.

Furthermore, the invention also pertains to a method for the hybrid MIG-TIG or MAG-TIG welding of metal parts implementing the device and installation of the invention. The welding of metal parts is performed by moving a hybrid MIG-TIG or MAG-TIG welding device according to the invention relative to the metal parts to be welded in a direction called the welding direction, and comprises the steps of:
a) generating a weld pool by melting the metal that forms the metal parts to be welded using a MIG or MAG electric arc established between the consumable wire 1a of the MIG or MAG-TIG welding torch 1 and the metal parts to be welded,
b) moving a TIG electric arc established between the non-consumable electrode 2a of the TIG welding torch 2 and the metal parts to be welded on at least part of the weld pool generated in step a), and
c) obtaining welded metal parts via the re-solidification of the metal that forms them.

In accordance with the invention, the end 2c of the non-consumable electrode 2a is positioned behind the first direction 1b of the consumable wire 1a in the welding direction, and a distance D or D′ away from said first direction 1b chosen based on the nature of the metal that forms the metal parts to be welded. The choice of the distance separating the end 2c of the non-consumable electrode 2a from the first direction 1b is based on the physical characteristics of the generated weld pool, particularly its viscosity and thermal conductivity, which vary based on the nature of the welded material.

The main application of the present invention is a method for welding metal parts made of ferrous alloys, aluminum, or aluminum alloy, preferably stainless steel or carbon steel.

When the metal parts to be welded are made of stainless steel, the end 2c of the non-consumable electrode 2a is preferably located a distance D away from the first direction 1b. When the metal parts to be welded are made of carbon steel, the end 2c of the non-consumable electrode 2a is preferably located a distance D′ away from the first direction 1b.

During the welding operation, the MIG or MAG-TIG electric arc and the TIG electric arc are protected by flows of shielding gas delivered by nozzles 30 and 40, respectively.

Advantageously, the MIG or MAG electric arc is shielded by a flow of gas containing mainly at least one inert compound chosen from helium and argon, preferably at least 80% (% by volume), and optionally a minority component with an oxidizing chemical effect chosen from CO₂ and O₂.

For example, for welding stainless steels, the MIG or MAG electric arc is preferably shielded by a flow of gas containing about 98% argon and 2% CO₂ (% by volume). For welding carbon steels, a flow of gas is preferably used containing a larger proportion of the oxidizing compound, for example a flow of gas containing about 92% argon and 8% CO₂ or containing 82% argon and 18% CO₂ (% by volume).

The TIG electric arc is shielded by a flow of gas containing essentially argon, preferably at least 99.9% (% by volume) or a mixture of helium and argon, for example a gas flow containing 80% argon and 20% helium or containing 30% argon and 70% helium, or a mixture containing at least 95% argon and hydrogen (% by volume).

As previously mentioned, advantageously the combination of a TIG arc is used with a MIG or MAG arc in order to fight against the “humping” phenomenon that appears at high welding speeds. In fact, the proximity between the two arcs and their rapid succession in a same zone of the joint involves that this same zone of the joint is successively struck first by the MIG or MAG arc, then by the TIG arc while the metal in that zone of joint is still liquid, meaning melted after the MIG or MAG arc had passed.

It follows that the TIG arc exerts its effect on the weld pool formed by the MIG or MAG arc while still liquid. The weld pool will then benefit from the flow of heat generated by the TIG arc so that it does not solidify; additionally, it benefits from the pressure exerted by that arc onto the lump of molten metal formed at the rear end of that pool, which makes it possible to obtain a weld bead without or almost without humping defects.

In order to demonstrate the effectiveness of the hybrid MIG-TIG or MAG-TIG welding device of the invention to weld metal parts, particularly thin parts, without defects and at high speed, hybrid MIG-TIG welding tests were conducted on plates 1.5 mm thick.

A first welding test was conducted on flat stainless steel parts. The welding parameters were as follows:
the MIG shielding gas contained 98% argon and 2% CO₂ (% by volume), corresponding to the ARCAL 12 mixture sold by AIR LIQUIDE,
the TIG shielding gas contained argon, corresponding to the ARCAL 1 mixture (about 99.998% pure argon by volume) sold by AIR LIQUIDE,
the distance D separating the end 2c of the TIG electrode 2a from the first direction 1b was 24 mm,
the angle α formed between the first direction 1b of the consumable wire 1a of the MIG torch and the second direction 2b of the non-consumable electrode 2a of the TIG torch was 20°,
the first direction 1b was perpendicular to the surface of the parts to be welded, i.e. it formed a 0° angle with the vertical,
the sharpening angle of the TIG electrode was 30°,
the TIG torch was supplied with a smooth 250A current,
the distance between the end of the electrode 2c and the parts to be welded was 3 mm,
the MIG torch was supplied by a smooth 272 A current, the arc voltage being 27 V and the distance between the nozzle of the MIG torch and the part being 13 mm,
the feeding speed of the consumable wire of the MIG torch was 13.2 m/min.

During these tests, a high welding speed, on the order of 3.2 m/min, was made possible, without the resulting beads having any “humping” defects. The resulting beads had good metallurgical characteristics.

A second welding test was conducted on flat carbon steel parts 1.5 mm thick. The welding parameters were as follows:
the MIG shielding gas contained 92% argon and 8% CO₂ (% by volume), corresponding to the ARCAL 21 mixture sold by AIR LIQUIDE,
the TIG shielding gas contained argon, corresponding to the ARCAL 1 mixture (about 99.998% pure argon by volume) sold by AIR LIQUIDE,
the distance D separating the end 2c of the TIG electrode 2a from the first direction 1b was 40 mm,
the angle α formed between the first direction 1b of the consumable wire 1a of the MIG torch and the second direction 2b of the non-consumable electrode 2a of the TIG torch was 20°,
the first direction 1b was perpendicular to the surface of the parts to be welded, i.e. it formed a 0° angle with the vertical,
the sharpening angle of the TIG electrode was 30°,
the TIG torch was supplied with a smooth 350A current,
the distance between the end of the electrode 2c and the parts to be welded was 3 mm,
the MIG torch was supplied by a pulsed 314 A current, the arc voltage being 32.4 V and the distance between the nozzle of the MIG torch and the part being 13 mm,
the feeding speed of the consumable wire of the MIG torch was 18.5 m/min.

During these tests, a high welding speed, on the order of 2.8 m/min, was made possible. The resulting beads had no “humping” defects and had good metallurgical characteristics.

The results of these tests confirm the benefits of the hybrid MIG-TIG welding device of the invention, which improves MIG welding performance and welds metal parts at high speed without the beads having any humping defects. Furthermore, it is possible, with a single device, to weld different types of materials for which the distances between the end of the TIG electrode and the direction of the MIG wire must be different. The device reduces the number of adjustments needed before welding the parts with the hybrid welding devices of the prior art because the torches are mechanically assembled by a shoe that allows predetermined relative positions of the two TIG and MIG or MAG torches. It is thereby possible, with a single device, to weld different types of materials. Furthermore, the device does not excessively complicate the welding installation, and does not require too much additional energy.

The invention is particularly advantage for improving the productivity of the method for welding metal parts thinner than 3 mm, and preferably thinner than 2 mm, because those thicknesses lead to high welding speeds at which the “humping” defect is likelier to occur.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-19. (canceled)

20. A hybrid MIG-TIG or MAG-TIG welding device comprising,
a MIG or MAG welding torch utilizing a consumable wire oriented in a first direction, associated with a TIG welding torch utilizing a non-consumable electrode oriented in a second direction, said first and second directions being substantially coplanar and forming between themselves an angle (a) no less than 5° and no greater than 40°,
a torch assembly shoe suitable and designed for allowing a positioning of the TIG welding torch in at least two predefined positions relative to the MIG or MAG welding torch, comprising:
a first position in which the end of the non-consumable electrode is located at a first distance away from the first direction, and
a second position in which the end of the non-consumable electrode is located at a second distance away from the first direction, the second distance being greater than the first distance.

21. The device according to claim 20, wherein the assembly shoe further comprises:
an axial lodging traversing the shoe in the first direction, inside which is arranged the MIG or MAG welding torch,
a first lateral lodging traversing the shoe in which the TIG welding torch is arranged when positioned in the first position, and
a second lateral lodging traversing the shoe in which the TIG welding torch is arranged when positioned in the second position.

22. The device according to claim 20, wherein the first distance is between 20 and 26 mm.

23. The device according to claim 20, wherein the second distance is between 36 and 44 mm.

24. The device according to claim 20, wherein said first and second directions form between them an angle (a) no less than 10° and no greater than 30°.

25. The device according to claim 20, wherein the shoe further comprises a means of fastening to hold the TIG welding torch in the first or second lateral lodgings.

26. The device according to claim 20, wherein the shoe further comprises a means of translationally adjusting the MIG or MAG welding torch along the first direction.

27. The device according to claim 20, comprising a clamp arranged in the axial lodging and into which the MIG or MAG welding torch is inserted.

28. The device according to claim 20, wherein the shoe is formed of one block.

29. A hybrid MIG-TIG or MAG-TIG welding installation comprising,
a MIG or MAG welding torch and a TIG welding torch electrically connected to at least one current generator and fluidly connected to at least one source of gas,
a moving beam onto which is arranged a hybrid MIG-TIG welding device according to claim 20, said hybrid MIG-TIG or MAG-TIG welding device being mobile or not, and
a numerical control suitable and designed for controlling the movement of the moving beam and/or the hybrid MIG-TIG or MAG-TIG welding device.

30. A method for the hybrid MIG-TIG or MAG-TIG welding of metal parts implementing a hybrid MIG-TIG or MAG-TIG welding device according to claim 20 and wherein, during welding:
a MIG or MAG electric arc is established between the consumable wire of the MIG or MAG welding torch and the metal parts to be welded so as to generate a weld pool, said MIG or MAG electric arc being protected by a gas flow containing mainly at least one inert compound chosen from helium and argon, and
a TIG electric arc is established between the non-consumable electrode of the TIG welding torch and the metal parts to be welded on at least some of said weld pool, said TIG electric arc being shielded by a gas flow containing mainly argon or a mixture of helium and argon.

31. The method according to claim 30, wherein the MIG or MAG electric arc is shielded by a flow of gas containing at least 80% of at least one inert compound chosen from helium and argon (% by volume).

32. The method according to claim 30, wherein the flow of gas shielding the MIG or MAG electric arc further contains a minority compound with an oxidizing chemical effect chosen from CO₂ and O₂.

33. The method according to claim 30, wherein when the welded parts are made of stainless steel, the flow of gas shielding the MIG or MAG electric arc contains about 98% argon and 2% CO₂ (% by volume).

34. The method according to claim 30, wherein when the welded parts are made of carbon steel, the flow of gas shielding the MIG or MAG electric arc contains about 92% argon and 8% CO₂ or 82% argon and 18% CO₂ (% by volume).

35. The method according to claim 30, wherein the flow of gas shielding the TIG electric arc contains essentially argon.

36. The method according to claim 30, wherein the flow of gas shielding the TIG electric arc contains at least 95% argon and hydrogen by volume.

37. The method according to claim 30, wherein the flow of gas shielding the TIG electric arc contains a mixture of helium and argon.

38. The method according to claim 30, wherein the flow of gas shielding the TIG electric arc contains:
either a mixture of 80% argon and 20% helium (% by volume), or
a mixture of 30% argon and 70% helium (% by volume).
